(19) United States
(12) Patent Application Publication
(10) Pub. No.: US 2022/0369591 A1
(43) Pub. Date: Nov. 24, 2022

(54) PET FOOD PRODUCT AND PET FOOD SPOON

(71) Applicant: Unicharm Corporation, Ehime (JP)

(72) Inventors: Tadatoshi Nobata, Itami-shi (JP); Sayaka Yamamoto, Itami-shi (JP); Yunyi Wong, Itami-shi (JP); Yuma Ikezaki, Itami-shi (JP)

(73) Assignee: Unicharm Corporation, Ehime (JP)

(21) Appl. No.: 17/747,299

(22) Filed: May 18, 2022

(30) Foreign Application Priority Data
May 21, 2021 (JP) 2021-086136

(51) Int. Cl. A01K 5/01; A23K 50/48; B65D 77/20; B65D 25/28

(52) U.S. Cl. CPC A01K 5/0121; A23K 50/48; B65D 77/2024; B65D 25/2888

(57) ABSTRACT

A pet food product includes a container including a housing and a holder. The housing contains wet food and includes: a bottom; and a peripheral wall extending upward from an outer peripheral edge of the bottom and surrounding the bottom. The holder protrudes outward from the peripheral wall.

### CROSS REFERENCES TO RELATED APPLICATIONS

The present application claims priority under 35 U.S.C. § 119 to Japanese Patent Application No. 2021-086136, filed on May 21, 2021. The contents of this application are incorporated herein by reference in their entirety.

### BACKGROUND

### Field

The present invention relates to a pet food product and a pet food spoon.

### Description of the Related Art

When pet foods are classified according to the purpose of feeding and the occasion, pet foods can be classified into staple foods and snacks. Pet food as a staple food is referred to as “comprehensive nutritional food” and is produced such that necessary nutrients can be taken in when this pet food and water are given.

On the other hand, “snack” is a pet food intended to be given in a limited amount aiming at training, exercise, and rewards for pets.

Regarding the categories of pet foods according to the purpose, pet foods are classified into “comprehensive nutritional foods”, “snacks”, “therapy foods”, and “other purpose foods” that do not fall under any of the categories.

Regarding the categories of pet foods according to the water content, pet foods are roughly divided into dry foods with a water content of about 10% (12% or less); soft foods with a water content of about 25% to 35%, which have been foamed; semi-moist foods with a water content of about 25% to 35%, which have not been foamed; and wet foods with a water content of about 75%.

Since wet foods are highly palatable for pets, the demand for wet foods has been ever increasing in recent years. Since wet foods have high water contents, a wet food is usually put in a container such as plate and given to pets when feeding.

On the other hand, with regard to commercial products that are consumed in a short period of time after breaking the seal, stick-shaped multilayer film containers (so-called stick type) are also frequently used.

The stick type has an advantage that it can be conveniently fed directly to pets. However, in stick-shaped film containers, when the contents are viscous articles, picking the container with fingertips and squeezing it to the end is often performed, and in the final squeezing, when squeezing is performed so as to have no contents remaining in the vicinity of the break opening, the contents may adhere to the fingertips and make the fingers and hands dirty. In contrast, a simple squeezer capable of squeezing out the contents without making the hands dirty has been proposed (see, for example, Patent Document 1).

### Patent Document

[Patent Document 1] Japanese Utility Model (Registered) Publication No. 3218518

When a wet food is put in a container such as a plate and given to pets when feeding, the container is often placed on the floor. However, when a pet is fed while the container is placed on the floor, the pet may take a burdensome posture, and there is a risk that the posture may impose a burden on the digestive system. Furthermore, when a pet is fed while the container is placed on the floor, for the feeder, there is a possibility that the pet food may scatter when the pet licks the wet food, and the floor may become dirty due to floor scratching caused by the plate sliding over the floor surface.

When a stick type wet food is directly fed to a pet, it is often the case that the contents are fed from above the pet so that the contents do not spill on the floor. However, when wet food is fed from above the pet, and a circumstance in which the pet is forced to adopt an unnatural posture occurs, there is a possibility that the pet's neck and hips may be strained.

Furthermore, in the stick type, since the wet food is present above the pet's face and body, when the timing of squeezing out the food is bad, the contents may spill, or the pet's face or hair may become dirty. When wet food adheres to the pet's hair, and time elapses in that state, the wet food will harden, making it difficult to wash off with water or the like, and it may be necessary to take measures such as cutting the hair.

Furthermore, in the stick type, when the remains of the contents are squeezed out, the feeder's hand may become dirty, or the pet may accidentally bite the hand. On the other hand, when a simple squeezer such as that of Patent Document 1 is used, not only it takes time to set the stick-shaped film container, but also both hands of the feeder are occupied during feeding. Therefore, it is difficult for the feeder to stroke the pet at the time of feeding and to take a picture of the pet at the time of feeding.

### SUMMARY

According to one or more embodiments of the invention, a pet food product can be conveniently fed by a feeder with one hand to a pet in a posture appropriate for the pet, and a pet food spoon.

One or more embodiments of the present invention include the following aspects.

(1) A pet food product including:

a container; and

a wet food,

in which the container has:

a bottom part (or “bottom”);

a peripheral wall part (or “peripheral wall”) extending upward from an outer peripheral edge of the bottom part while surrounding a perimeter of the bottom part at the same time, the peripheral wall part defining, together with the bottom part, a housing part (or “housing”) that opens upward; and

a holding part (or “holder”) protruding outward from the peripheral wall part, and

the wet food is housed in the housing part.

(2) The pet food product according to the above-described item (1), in which the holding part has a length of 20 mm or more.

(3) The pet food product according to the above-described item (1) or (2), in which the holding part has a length of 40 mm or less.

(4) The pet food product according to any one of the above-described items (1) to (3), in which the housing part has a depth of 20 mm or less.

(5) The pet food product according to any one of the above-described items (1) to (4), in which the housing part has a depth of 10 mm or more.

(6) The pet food product according to any one of the above-described items (1) to (5), in which the housing part has an opening diameter of φ20 mm or more.

(7) The pet food product according to any one of the above-described items (1) to (6), in which the housing part has an opening diameter of φ50 mm or less.

(8) The pet food product according to any one of the above-described items (1) to (7), in which the bottom part has a polygonal shape having six or more sides in a plan view.

(9) The pet food product according to any one of the above-described items (1) to (8), in which the bottom part has a circular shape in a plan view.

(10) The pet food product according to any one of the above-described items (1) to (9), in which an angle formed by an axis line orthogonal to a horizontal plane on which the bottom part is present, and the holding part is 45° to 90°.

(11) The pet food product according to any one of the above-described items (1) to (10), in which a viscosity of the wet food as measured by a Bostwick viscometer is 5 mm/min or greater.

(12) The pet food product according to any one of the above-described items (1) to (11), in which the viscosity of the wet food as measured by a Bostwick viscometer is 60 mm/min or less.

(13) The pet food product according to any one of the above-described items (1) to (12), further including a lid that is removably joined to an opening edge part (or “opening edge”).

(14) The pet food product according to any one of the above-described items (1) to (13), in which the lid has a detachable part, and the detachable part is provided on a holding part side.

(15) A pet food spoon including:

a bottom part;

a peripheral wall part extending upward from an outer peripheral edge of the bottom part while surrounding a perimeter of the bottom part at the same time, the peripheral wall part defining, together with the bottom part, a housing part that opens upward; and

a holding part protruding outward from the peripheral wall part.

According to one or more embodiments of the present invention, a pet food product that can be conveniently fed by a feeder with one hand to a pet in a posture appropriate for the pet, and a pet food spoon can be provided.

### BRIEF DESCRIPTION OF THE DRAWINGS

FIG. 1 is a perspective view showing a pet food product according to one or more embodiments.

FIG. 2 is a cross-sectional view of the pet food product according to one or more embodiments taken along the line I-I′ of FIG. 1.

FIG. 3 is a plan view of the pet food product according to one or more embodiments.

FIG. 4 is a plan view showing a shape example of a holding part in the pet food product according to one or more embodiments.

FIG. 5 is a perspective view showing a pet food product according to one or more embodiments.

FIG. 6 is a cross-sectional view showing a pet food product according to one or more embodiments.

FIG. 7 is a cross-sectional view showing a pet food product according to one or more embodiments.

### DETAILED DESCRIPTION OF THE EMBODIMENTS

In the present specification, the term “pet” refers to an animal raised by a human. In a narrower sense, a pet is an animal that is cherished by its owner. Furthermore, the “pet food” means feed for pets. The pet food according to one or more embodiments can be sold as “animal fodder” or “animal feed”.

The term “palatability” in the present specification is an index indicating whether a pet likes to eat, and palatability arises from mouthfeel, taste, odor, and the like.

In the present specification, the water content percentage (% by weight) of a pet food is determined by a normal pressure heating and drying method. The water content percentage determined by this method also includes the water in the ingredients.

(Normal Pressure Heating and Drying Method)

The weight of an aluminum weighing can (W1 grams) is measured in advance as a constant weight value. A sample is introduced into this aluminum weighing can, and the weight (W2 grams) is weighed. Next, the sample is dried under the conditions of 135° C. for 2 hours by using a forced circulation type warm air dryer. After the sample is left to cool in a dry atmosphere (in a silica gel desiccator), the weight (W3 grams) is weighed. From each of the weights obtained, the water content percentage is determined by using the following formula.

Water content percentage (unit: % by weight)=(W2−W3)÷(W2−W1)×100

<Pet Food Product>

Hereinafter, embodiments of the pet food product of the present invention will be described in detail with reference to the drawings. In each embodiment that will be described below, equivalent configurations may be assigned with the same reference numerals, and description thereof will not be repeated.

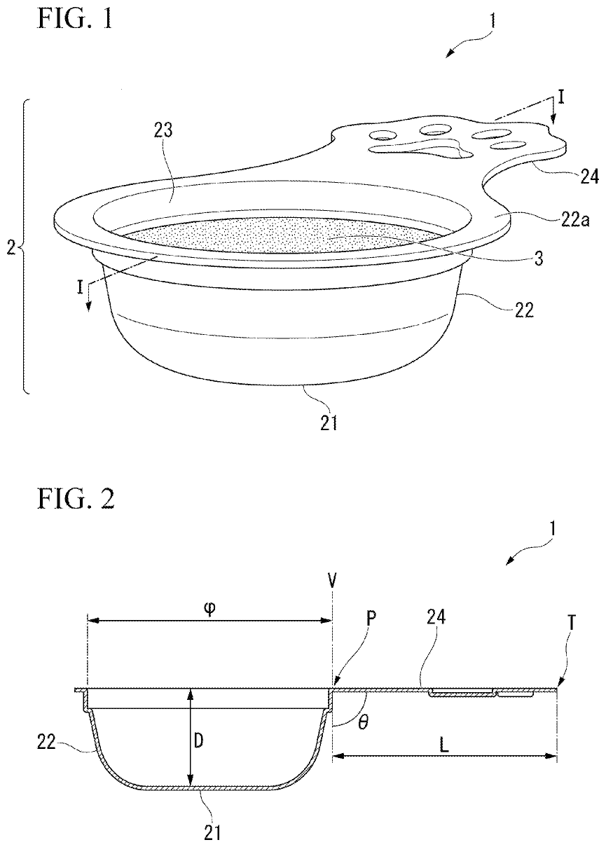

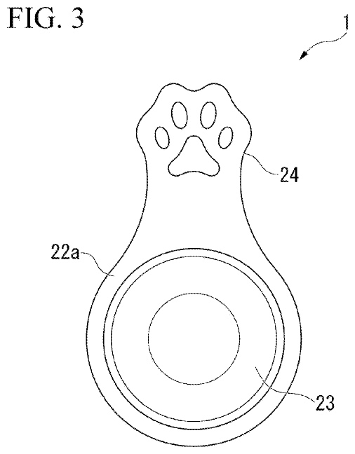

FIG. 1 is a perspective view showing a pet food product according to one or more embodiments. FIG. 2 is a cross-sectional view of the pet food product according to one or more embodiments taken along the line I-I′ of FIG. 1. FIG. 3 is a plan view of the pet food product according to one or more embodiments.

As shown in FIG. 1, the pet food product 1 includes a container 2 and a wet food 3 housed in the container 2.

(Container)

The container 2 has a bottom part 21; a peripheral wall part 22 extending upward from the outer peripheral edge of the bottom part 21 while surrounding the perimeter of the bottom part 21 at the same time, the peripheral wall part 22 defining, together with the bottom part 21, a housing part 23 that opens upward; and a holding part 24 protruding outward from the peripheral wall part 22.

The material of the container 2 is not particularly limited; however, from the viewpoints of formability and storage stability of the wet food, it may be a thermoplastic resin, a metal such as aluminum or steel, a paper material used for food containers, and an edible material such as biscuits, and it may be a thermoplastic resin.

According to the pet food product according to one or more embodiments, since the feeder can feed by hand, the pet food product can be disposed under the pet's face without moving the container or the contents, and therefore, it is possible to feed the pet in a posture appropriate for the pet. Furthermore, unlike stick-type wet foods, the feeder does not need to squeeze the food out, and therefore, it is possible to feed the pet conveniently with one hand with satisfactory handleability. Therefore, the feeder can feel the sense of happiness by stroking the pet when feeding, and can make memories such as taking a picture of the pet when feeding, so that the intimacy between the feeder and the pet can be increased, and this can contribute to improving the health of the feeder and the pet.

In FIG. 1, the bottom part 21 has a circular shape. However, in one or more embodiments, the shape of the bottom part 21 is not particularly limited, and examples of the shape include a circular shape, an elliptical shape, a combination of two or more circles, a donut shape; polygonal shapes such as a triangle, a quadrangle, a pentagon, a hexagon, and an octagon; and irregular shapes such as a star shape, a heart shape, and a cat face motif.

Above all, from the viewpoint of facilitating feeding in a posture appropriate for the pet without producing leftovers of the pet food, the bottom part 21 may have a polygonal shape having six or more sides in a plan view or a circular shape.

The peripheral wall part 22 extends upward from the outer peripheral edge of the bottom part 21 while surrounding the perimeter of the bottom part 21 at the same time and defines, together with the bottom part 21, a housing part 23 that opens upward.

The peripheral wall part 22 may be formed at the same height over the entire perimeter or may be formed such that the heights are partially different.

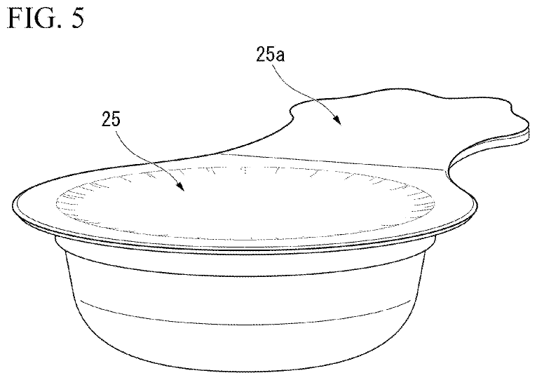

The peripheral wall part 22 may have an opening edge part 22a projecting horizontally from the upper end part thereof. A removably joined lid 25 may be installed on the opening edge part 22a (see FIG. 5). The width of the opening edge part 22a is not particularly limited; however, the width may be 1 to 10 mm, 2 to 8 mm, or 3 to 6 mm.

The thickness of the opening edge part 22a is not particularly limited; however, the thickness may be 0.3 to 1 mm, 0.4 mm to 0.9 mm, or 0.5 mm to 0.8 mm.

The depth of the housing part 23 is not particularly limited; however, the depth may be 10 mm or more, or 12 mm or more. Furthermore, the depth of the housing part 23 may be 20 mm or less, or 18 mm or less.

When the depth of the housing part 23 is equal to or more than the lower limit value of the above-described range, it is easy to feed the pet in a posture appropriate for the pet, without causing a spillage of the pet food. On the other hand, when the depth of the housing part 23 is equal to or less than the upper limit value of the above-described range, it is easy to feed the pet in a posture appropriate for the pet, without making the pet's face dirty.

According to one or more embodiments, the depth of the housing part 23 is the distance D from the lowest point of the bottom part 21 to the uppermost point of the opening of the housing part 23 in a side sectional view of the pet food product 1.

The opening diameter of the housing part 23 is not particularly limited; however, the opening diameter may be φ20 mm or more, φ25 mm or more, or φ30 mm or more. Furthermore, the opening diameter of the housing part 23 may be φ50 mm or less, φ45 mm or less, or φ40 mm or less.

When the opening diameter of the housing part 23 is equal to or more than the lower limit value of the above-described range, it is easy to feed the pet in a posture appropriate for the pet, without causing a spillage of the pet food. On the other hand, when the opening diameter of the housing part 23 is equal to or less than the upper limit value of the above-described range, it is easy to feed the pet in a posture appropriate for the pet, without making the pet's face dirty.

According to one or more embodiments, the opening diameter φ of the housing part 23 is the maximum diameter at the uppermost point of the opening of the housing part 23 in a side sectional view of the pet food product 1.

The holding part 24 protrudes outward from the peripheral wall part 22. From the viewpoint of handleability of the feeder, the holding part 24 may extend in an approximately horizontal direction from the upper part of the peripheral wall part 22, the holding part 24 may extend in an approximately horizontal direction from the upper part of the peripheral wall part 22, or and the holding part 24 and the opening edge part 22a may be approximately horizontal, while the holding part 24 extends in an approximately horizontal direction from the opening edge part 22a.

Furthermore, the holding part 24 may have a recessed part. When the holding part 24 has a recessed part, the feeder will not slip easily even when the holding part 24 is held by one hand. In addition, at the time of feeding, it is easier for the feeder to feed the pet food product 1 with one hand so that the pet can eat in a correct posture. In the example shown in FIG. 1, the recessed part has a shape of a cat's paw; however, the shape of the recessed part is not limited to this, and various animals, plants, and geometric patterns can be adopted.

The length of the holding part 24 is not particularly limited; however, the length may be 20 mm or more, 22 mm or more, or 25 mm or more. The length of the holding part 24 may be 40 mm or less, 39 m or less, or 38 mm or less.

When the length of the holding part 24 is equal to or more than the lower limit value of the above-described range, it is easy to feed the pet in a posture appropriate for the pet, without making the pet's face and the feeder's hand dirty. Furthermore, the pet food is less likely to spill, and it is easy to prevent the occurrence of soiling. On the other hand, when the length of the holding part 24 is equal to or less than the upper limit value of the above-described range, the container is not easily shaken, and it is easy to feed the pet in a posture appropriate for the pet. Furthermore, the pet food is less likely to spill, and it is easy to prevent the occurrence of soiling.

According to one or more embodiments, the length of the holding part 24 refers to the distance L from the point P where the end part of the peripheral wall part 22 meets the end part of the holding part 24, to the other end part T of the holding part 24, in a side sectional view of the pet food product 1.

The width of the holding part 24 is not particularly limited; however, the width may be 15 to 35 mm, 16 to 30 mm, or 17 to 25 mm. According to one or more embodiments, the width of the holding part 24 refers to the average value of the maximum width and the minimum width of the holding part 24 in a plan view of the pet food product 1.

The thickness of the holding part 24 is not particularly limited; however, the thickness may be 0.1 to 1 mm, 0.2 to 0.9 mm, or 0.3 to 0.8 mm. According to one or more embodiments, the thickness of the holding part 24 refers to the average value of the maximum thickness and the minimum thickness of the holding part 24 in a side sectional view of the pet food product 1.

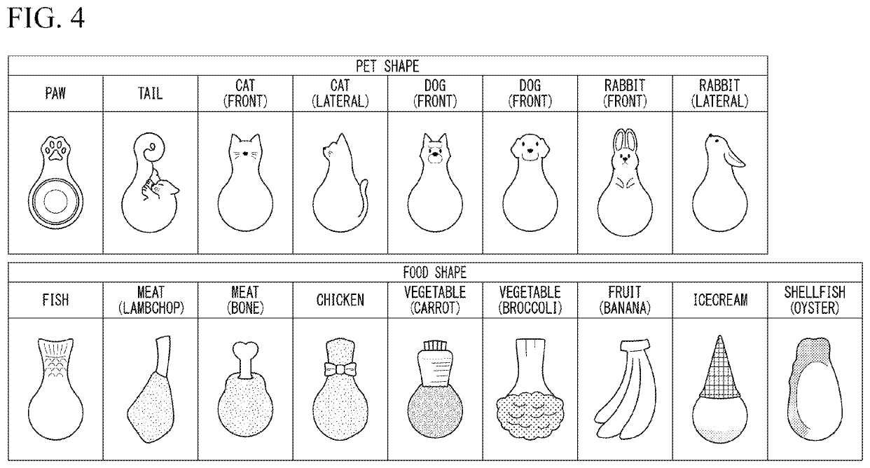

The shape of the holding part 24 is not particularly limited as long as the feeder can hold it with one hand. FIG. 4 is a plan view showing examples of the shape of the holding part in the pet food product according to one or more embodiments. Specifically, examples of the shape of the holding part 24 include, in a plan view, shapes with pet motifs, such as a paw, a tail, a cat (front or lateral), a dog (front or lateral), a rabbit (front or lateral), a mouse, a chicken, and a deer; shapes with food motifs, such as fish, meat (lambchop, meat-on-bone, or the like), chicken, carrot, broccoli, a fruit (banana or the like), ice cream, and shellfish (oyster or the like); polygonal shapes such as a circle, a triangle, a quadrangle, a trapezoid, and a pentagon; combinations of irregular shapes such as a star, a heart, a clover, a ribbon, and a crown, with long shapes; shapes with plant motifs, such as a flower; and combinations of shapes with tableware motifs, such as a fork, with shapes with food motifs, such as boiled eggs. Incidentally, the holding part and the housing part may have various animal, plant, and geometric patterns; however, the shapes are not limited to these.

The angle θ formed by the axis V that is orthogonal to the horizontal plane on which the bottom part 21 is present and the holding part 24 may be 45° to 90°, 60° to 90°, or 70° to 90°. When the angle θ is within the above-described range, it is easy to feed the pet in a posture appropriate for the pet.

### Modification Examples of Container

FIG. 5 is a perspective view showing a pet food product according to one or more embodiments. In one or more embodiments shown in FIG. 5, a lid 25 removably joined to the opening edge part 22a is provided.

By providing the lid 25, the wet food 3 in the housing part 23 can be prevented from drying until feeding. By keeping the wet food 3 in a satisfactory condition, it is easier to feed the pet in a posture appropriate for the pet.

As shown in FIG. 5, the lid 25 may have a detachable part 25a on the holding part 24 side. In this case, the lid 25 may be removably joined to the opening edge part 22a, and the detachable part 25a extends over the holding part 24 without being joined to the holding part 24. When the lid 25 has the detachable part 25a on the holding part 24 side, it is easy to prevent the wet food 3 from spilling from the housing part 23 when the lid 25 is removed immediately before feeding.

Furthermore, according to one or more embodiments, when a position on the peripheral wall part 22 farthest from the holding part 24 side is referred to as “forepart peripheral wall part 22b”, a position on the peripheral wall part 22 closest to the holding part 24 side is referred to as “hindpart peripheral wall part 22c”, and the difference in height between the forepart peripheral wall part 22b and the hindpart peripheral wall part 22c is 0 to 10 mm, since an angle is formed in the bottom part 21, it is easy to feed the pet, and the pet can easily eat wet food. According to one or more embodiments, the height of the forepart peripheral wall part 22b may be 0.5 to 5 mm lower than the height of the hindpart peripheral wall part 22c.

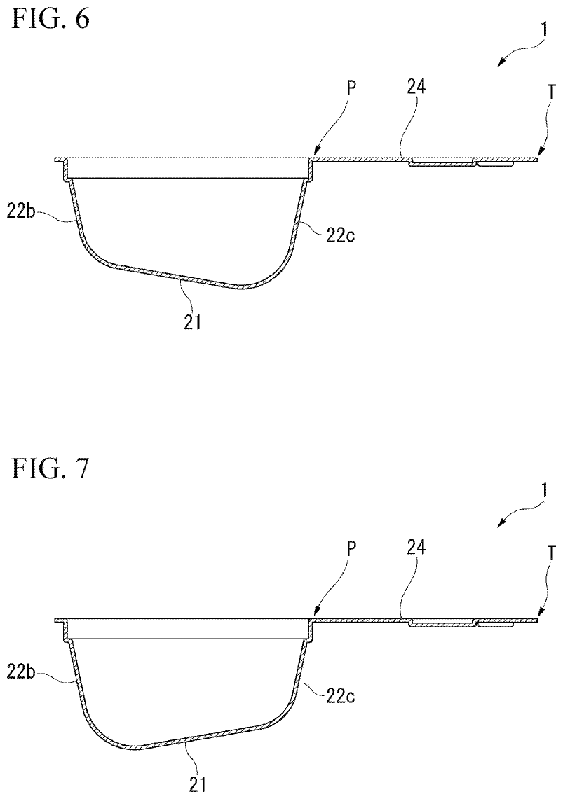

FIG. 6 is a cross-sectional view showing a pet food product according to one or more embodiments. In FIG. 6, the height of the forepart peripheral wall part 22b is formed to be lower than the height of the hindpart peripheral wall part 22c. In one or more embodiments of FIG. 6, the pet food is less likely to spill from the housing part 23 during feeding, and the pet can easily lick the wet food 3. Therefore, it is easy to feed the pet in a posture appropriate for the pet, without making the pet's face dirty.

FIG. 7 is a cross-sectional view showing a pet food product according to one or more embodiments. In FIG. 7, the height of the forepart peripheral wall part 22b is formed to be higher than the height of the hindpart peripheral wall part 22c. In one or more embodiments of FIG. 7, in order to make the wet food 3 that the pet has not completely licked in the forepart of the housing part 23, to be cleanly licked, the pet food product can be designed to change the feeding angle of the pet food product, or the like. Therefore, the time for the pet to lick the wet food is slightly prolonged compared to the time of normal feeding, the pet's various facial expressions can be seen during feeding, and the communication time with the pet can be increased.

Furthermore, in one or more embodiments of FIG. 7, for example, even when the pet food product is placed on the floor, a table, or the like when feeding is temporarily stopped, the pet food product 1 can be stably disposed on the floor, a table, or the like by the bottom part 21 and the holding part 24.

(Wet Food)

According to one or more embodiments, the wet food refers to a pet food including a large amount of water as compared with a dry food that has been subjected to a drying treatment, as a final form offered to the market. The water content percentage of the pet food usually 50% by mass or more, and it may be 60% by mass or more, 65% by mass or more, or 70% by mass or more, with respect to the total mass of the pet food.

The wet food typically includes a base meat portion and may further include a chunk portion and/or flakes. Here, the term “chunk” refers to a portion obtained by solidifying raw materials into small pieces, and the chunk portion refers to a set of chunks. The term “flakes” refers to finely divided fish and meat pieces. The “base meat” part refers to a wet portion of the pet food other than the chunk portion and the flake part.

The proportion of the chunk portion and/or flakes included in the wet food is not particularly limited, and the proportion may be 0% to 30% by mass, or 0% to 25% by mass, with respect to the total mass of the pet food.

The shape of the chunk is not particularly limited, and examples thereof include shapes formed into pellets (grains), such as a spherical shape, a polygonal shape, a columnar shape, a donut shape, a plate shape, or a Go-stone shape. The size of such a pellet is not particularly limited; however, for example, when a pellet placed on a horizontal table is viewed from above, the minor axis and the major axis may be 1 to 25 mm and the thickness from the lower surface (lower end) to the upper surface (upper end) of the pellet on the horizontal table is 1 to 20 mm; the minor axis and the major axis may be 3 to 11 mm and the thickness is 3 to 9 mm; or the minor axis and the major axis may be 5 to 9 mm and the thickness is 5 to 8 mm.

The mode of the base meat portion is not particularly limited, and examples thereof include modes such as a liquid form, a gel form, a solid form, and the like, or combinations thereof. Furthermore, when the base meat portion contains a solid, the shape is not particularly limited, and examples thereof include shapes similar to the above-described shapes of chunks.

The proportions of proteins, carbohydrates, and lipids included in the wet food are not particularly limited. For example, the proportion of the proteins included in the pet food can be 26% to 60% by mass, or 35% to 55% by mass, with respect to the total mass of the pet food in terms of dry matter. The proportion of the carbohydrates included in the pet food can be 5% to 30% by mass, or 10% to 20% by mass, with respect to the total mass of the pet food in terms of dry matter. Furthermore, the proportion of the lipids included in the pet food can be 9% to 30% by mass, or 20% to 30% by mass, with respect to the total mass of the pet food in terms of dry matter.

According to one or more embodiments, the viscosity of the wet food measured by a Bostwick viscometer may be 5 mm/min or more, 7 mm/min or more, or 10 mm/min or more. The viscosity of the wet food measured by the Bostwick viscometer may be 60 mm/min or less, 59 mm/min or less, or 58 mm/min or less.

When the viscosity of the wet food is within the above-described range, it is easy to feed the pet in a posture appropriate for the pet, without making the pet's face dirty or causing scattering of the pet food.

The pet food product according to one or more embodiments may be intended particularly for cats, small dogs, or ultra-small dogs.

<Raw Materials>

The raw materials constituting the wet food are not particularly limited, and the raw materials used for the conventional pet foods can be applied. For example, in addition to protein components, carbohydrate components, vitamins, minerals, salts, fats, oils, extracts of animal foodstuffs, and the like may be added.

When preparing a wet food, a thickener may be added as a raw material.

Examples of the thickener include polysaccharides such as guar gum, starch, carrageenan, xanthan gum, and locust bean gum.

When fish such as tuna, sardine, and bonito, or domestic animals such as beef, pork, and chicken are used as the protein components included in the raw materials of the wet food, these raw materials may be heated or cooked in advance by known methods.

The wet food can be produced by, for example, mixing protein components and water, and adding a thickener as necessary. The mixing method is not particularly limited, any known method of using a mixer or a mincer can be applied, and it a method capable of uniformly mixing may be employed. Each of the raw materials can be mixed more uniformly by mixing (processing) the protein components in advance into minced meat and then mixing the minced meat with other raw materials. After mixing, the pet food may be prepared into a paste form. Furthermore, clumpy (solid) ingredients may be dispersed in the paste-like pet food. As the raw materials in the pet food are uniformly mixed, or the pet food is in the form of a paste, it is possible to suppress the pet from eating only a portion of the pet food or only some of the raw materials, and the rate of complete eating can be enhanced.

The time and temperature for mixing the raw materials can be appropriately set. By adjusting the mixing time, the viscosity of the pet food can be adjusted. Furthermore, the viscosity and the water content of the pet food can be adjusted by adjusting the amount of water to be mixed. The viscosity of pet food can also be adjusted by the blending amount of the thickener. Furthermore, the FW can be adjusted by adjusting the weight of the material containing solid components with respect to the weight of all the materials constituting the pet food.

Usually, wet food is not in the form in which solid ingredients and a liquid soup are separated from each other, but has a form in which only the paste-like component having the above-mentioned specific viscosity and water content, or the paste-like component and solid ingredients are entangled. The wet food may not be in the form in which the soup component and the solid ingredients are separated, but at least partially has a paste-like form (component) having the above-mentioned viscosity and water content. In addition to the paste-like component, the pet food may contain a solid ingredient. In this case, since the solid ingredient is in a form of being entangled with the paste-like component, the solid ingredient is carried into the pet's mouth together with the paste-like component. The rate of complete eating of the wet food can be enhanced.

When the wet food includes a chunk portion, the chunk portion and the base meat portion can be produced by using the raw materials as shown below.

(Raw Materials for Base Meat Portion)

The raw materials included in the base meat portion of the wet food are not particularly limited; however, a protein raw material can be used as the raw material in the base meat portion. Examples of the protein raw material of the base meat portion include plant-derived proteins, animal-derived proteins, and mixtures thereof. Specifically, examples of the plant-derived proteins include gluten, wheat protein, soybean protein, rice protein, and corn protein. Examples of the animal-derived proteins include proteins such as muscles and organs of cattle, pig, chicken, and fish and shellfish; proteins of milk; or mixtures thereof.

As raw materials other than the above-described ones in the base meat portion, fats and oils, a chicken extract, a fish extract, seasonings, a thickener, water, and the like can be added.

(Chunk Portion Raw Material)

A protein raw material can be used for the chunk portion of the pet food. Regarding the protein raw material for the chunk portion, protein raw materials similar to those used for the base meat portion can be used.

Furthermore, cereals may be added to the chunk portion of the pet food. Regarding the cereals, corn, wheat, barley, oats, rice, and soybean can be mentioned as examples. Since these cereals may include proteins, ash, minerals, vitamins, and the like in addition to carbohydrates, the cereals can be used as a nutrient source. Furthermore, by adding cereals, it is easy to adjust (mainly reduce) the blending ratio of amino acids with respect to the entire pet food.

Regarding the raw materials other than the above-described ones for the chunk portion, seasonings, a binder, water, and the like can be added.

<Pet Food Spoon>

The pet food spoon according to one or more embodiments is similar to the container of the pet food product according to one or more embodiments.

According to one or more embodiments, since the feeder can feed by hand, the pet food product can be disposed under the pet's face without moving the container or the contents, and therefore, it is possible to feed the pet in a posture appropriate for the pet. Furthermore, unlike stick-type wet foods, the feeder does not need to squeeze the food out, and therefore, it is possible to feed the pet conveniently with one hand with satisfactory handleability. Therefore, the feeder can feel the sense of happiness by stroking the pet when feeding, and can make memories such as taking a picture of the pet when feeding, so that the intimacy between the feeder and the pet can be increased, and this can contribute to improving the health of the feeder and the pet.

The pet food spoon according to one or more embodiments may be intended particularly for cats, small dogs, or ultra-small dogs.

Furthermore, the pet food spoon according to one or more embodiments may be used for feeding wet food.

### EXAMPLES

Hereinafter, the present invention will be described in more detail by way of Examples; however, the present invention is not intended to be limited to these examples.

[Production of Wet Food]

A wet food was produced by mixing 30% tuna, 2.8% a thickener, water, and 67.2% an extract, and pulverizing the mixture with a mixer to be mixed uniformly.

### Test Example 1: Evaluation of Length of Holding Part

Pet food products as shown in FIG. 1 were produced by employing the lengths of the holding part shown in Table 1. In each example, the shape of the container is the same except for the length of the holding part. Furthermore, in each example, a wet food of the same composition was adopted.

The pet food product of each example was fed to a cat, and the remains of the pet food, spills, and the ease of feeding were evaluated according to the following criteria. The results are shown in Table 1.

<Evaluation of Remains of Food>

A: Eating completed (5% or less of the pet food remained in the housing part).

B: A slight amount remained (more than 5% to 10% of the pet food remained in the housing part).

C: A considerable amount remained (more than 10% of the pet food remained in the housing part).

<Evaluation of Spills>

The presence or absence of spills was checked when feeding cats.

<Evaluation of Ease of Giving>

A: Soiling occurred on neither the cat nor the feeder.

B: The cat's face or the feeder's hand was slightly soiled.

C: The cat's face or the feeder's hand was soiled.

TABLE 1

| | Length of | | | |
|---|---|---|---|---|
| | holding | Remains | | Ease of |
| | part (mm) | of food | Spills | giving |
| Test Example 1-1 | 10 | A | Present | C |
| Test Example 1-2 | 30 | A | Absent | A |
| Test Example 1-3 | 50 | A | Absent | B |
| Test Example 1-4 | 70 | B | Present | C |

In Test Example 1-1, it was found that since the distance between the feeder's hand and the housing part is short, the feeder's hand becomes dirty due to the pet food hitting the feeder's hand, the cat licking the feeder's hand, or the like. In Test Example 1-4, it was found that since the distance between the feeder's hand and the housing part is long, the container is shaken during feeding, the housing part hits the cat's face, and the area around the cat's mouth becomes dirty.

Therefore, from the results shown in Table 1, it was confirmed that the length of the holding part may be 20 mm or more and 40 mm or less.

### Test Example 2: Evaluation of Depth of Housing Part

Pet food products as shown in FIG. 1 were produced by employing the depths of the housing part shown in Table 2. In each example, the shape of the container is the same except for the depth of the housing part. Furthermore, in each example, a wet food of the same composition was adopted.

The pet food product of each example was fed to a cat, and the remains of the pet food, spills, and the soiling around the mouth were evaluated according to the following criteria. The results are shown in Table 2.

<Evaluation of Remains of Food>

A: Eating completed (5% or less of the pet food remained in the housing part).

B: A slight amount remained (more than 5% to 10% of the pet food remained in the housing part).

C: A considerable amount remained (more than 10% of the pet food remained in the housing part).

<Evaluation of Spills>

The presence or absence of spills of the pet food was checked when feeding cats.

<Soiling Around Mouth>

The presence or absence of soiling around the cat's mouth was checked when feeding cats.

TABLE 2

| | Depth of | | | Soiling |
|---|---|---|---|---|
| | housing | Remains | | around |
| | part (mm) | of food | Spills | mouth |
| Test Example 2-1 | 30 | B | Absent | Present |
| Test Example 2-2 | 15 | A | Absent | Absent |
| Test Example 2-3 | 10 | A | Present | Absent |

From the results shown in Table 2, it was confirmed that the depth of the housing part may be 10 mm or more and 20 mm or less.

### Test Example 3: Evaluation of Opening Diameter of Housing Part

Pet food products as shown in FIG. 1 were produced by employing the opening diameters of the housing part shown in Table 3. In each example, the shape of the container is the same except for the opening diameter of the housing part. Furthermore, in each example, a wet food of the same composition was adopted.

The pet food product of each example was fed to a cat, and the remains of the pet food and soiling around the mouth were evaluated according to the following criteria. The results are shown in Table 3.

<Evaluation of Remains of Food>

A: Eating completed (5% or less of the pet food remained in the housing part).

B: A slight amount remained (more than 5% to 10% of the pet food remained in the housing part).

C: A considerable amount remained (more than 10% of the pet food remained in the housing part).

<Soiling Around Mouth>

The presence or absence of soiling around the cat's mouth was checked when feeding cats.

TABLE 3

| | Opening | | |
|---|---|---|---|
| | diameter of | | Soiling |
| | housing | Remains | around |
| | part (φmm) | of food | mouth |
| Test Example 3-1 | 25 | A | Absent |
| Test Example 3-2 | 39 | A | Absent |
| Test Example 3-3 | 55 | A | Present |

From the results shown in Table 3, it was confirmed that the opening diameter of the housing part may be φ20 mm or more and φ50 mm or less.

### Test Example 4: Evaluation of Shape of Bottom Part

Pet food products as shown in FIG. 1 were produced by employing the shapes of the bottom part shown in Table 4. In each example, the shape of the container is the same except for the shape of the bottom part. Furthermore, in each example, a wet food of the same composition was adopted.

The pet food product of each example was fed to a cat, and the remains of the pet food was evaluated according to the following criteria. The results are shown in Table 4.

<Evaluation of Remains of Food>

A: Eating completed (5% or less of the pet food remained in the housing part).

B: A slight amount remained (more than 5% to 10% of the pet food remained in the housing part).

C: A considerable amount remained (more than 10% of the pet food remained in the housing part).

TABLE 4

| | Shape of | Remains |
|---|---|---|
| | bottom part | of food |
| Test Example 4-1 | Circle | A |
| Test Example 4-2 | Quadrangle | C |
| Test Example 4-3 | Octagon | B |

From the results shown in Table 4, it was confirmed that the shape of the bottom part may be a polygonal shape having 6 or more sides in a plan view.

### Test Example 5: Evaluation of Viscosity of Wet Food

Wet foods having the viscosities shown in Table 5 were employed, and pet food products as shown in FIG. 1 were produced. In each example, the shape of the container is the same. The viscosity of the wet food is a value measured by a Bostwick viscometer.

The pet food product of each example was fed to a cat, and the remains of the pet food and spills were evaluated according to the following criteria. The results are shown in Table 5.

<Evaluation of Remains of Food>

A: Eating completed (5% or less of the pet food remained in the housing part).

B: A slight amount remained (more than 5% to 10% of the pet food remained in the housing part).

C: A considerable amount remained (more than 10% of the pet food remained in the housing part).

<Evaluation of Spills>

The presence or absence of spills of the pet food was checked when feeding cats.

TABLE 5

| | Viscosity of | | |
|---|---|---|---|
| | wet food | Remains | |
| | (mm/min) | of food | Spills |
| Test Example 5-1 | 2 | B | Present |
| Test Example 5-2 | 11 | A | Absent |
| Test Example 5-3 | 35 | A | Absent |
| Test Example 5-4 | 58 | A | Absent |
| Test Example 5-5 | 62 | A | Present |
| Test Example 5-6 | 69 | A | Present |

From the results shown in Table 5, it was confirmed that the viscosity of the wet food measured by the Bostwick viscometer may be 5 mm/min or more and 60 mm/min or less.

While embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

### EXPLANATION OF REFERENCES

1: Pet food product
2: Container
21: Bottom part
22: Peripheral wall part
23: Housing part
24: Holding part
3: Wet food

What is claimed is:

1. A pet food product comprising:
a container comprising:
a housing containing wet food and comprising:
a bottom; and
a peripheral wall extending upward from an outer peripheral edge of the bottom and surrounding the bottom; and
a holder protruding outward from the peripheral wall.

2. The pet food product according to claim 1, wherein the holder has a length of 20 mm or more.

3. The pet food product according to claim 1, wherein the holder has a length of 40 mm or less.

4. The pet food product according to claim 1, wherein the housing has a depth of 20 mm or less.

5. The pet food product according to claim 1, wherein the housing has a depth of 10 mm or more.

6. The pet food product according to claim 1, wherein the housing has an opening diameter of φ20 mm or more.

7. The pet food product according to claim 1, wherein the housing has an opening diameter of φ50 mm or less.

8. The pet food product according to claim 1, wherein the bottom has a polygonal shape having six or more sides in a plan view.

9. The pet food product according to claim 1, wherein the bottom has a circular shape in a plan view.

10. The pet food product according to claim 1, wherein an angle between 45° and 90° is formed by the holder and an axis orthogonal to a horizontal plane of the bottom.

11. The pet food product according to claim 1, wherein a viscosity of the wet food measured by a Bostwick viscometer is 5 mm/min or more.

12. The pet food product according to claim 1, wherein a viscosity of the wet food measured by a Bostwick viscometer is 60 mm/min or less.

13. The pet food product according to claim 1, further comprising a lid that is removably joined to an opening edge of the peripheral wall.

14. The pet food product according to claim 13, wherein the lid has a detachable part disposed on a holder side of the pet food product.

15. A pet food spoon comprising:
a housing comprising:
a bottom; and
a peripheral wall extending upward from an outer peripheral edge of the bottom and surrounding the bottom; and
a holder protruding outward from the peripheral wall.
